(19) United States
(12) Patent Application Publication
(10) Pub. No.: US 2020/0184484 A1
(43) Pub. Date: Jun. 11, 2020

(54) System and Method for the Distributed Approval of Image Based Claims

(71) Applicant: Walmart Apollo, LLC, Bentonville, AR (US)

(72) Inventor: Andrew B. Millhouse, Gilbert, AZ (US)

(21) Appl. No.: 16/212,218

(22) Filed: Dec. 6, 2018

(51) Int. Cl. G06Q 30/00; G06T 7/00

(52) U.S. Cl. CPC G06Q 30/016; G06T 7/0002

(57) ABSTRACT

A system and a method for the distributed approval of image-based claims are disclosed. The system receives a claim and one or more claim images of an item, and retrieves one or more control images of an item of similar type. The system presents the claim images and control images in a graphical user interface that randomly arranges the images. The system receives input from each of a group of individuals indicating a ranking corresponding to a state of damage of the item portrayed in each of the images, where the ranking is relational to each of the images. The system determines an overall ranking of the claim based on the ranking of the images received from the individuals. The system automatically approves or denies the claim based on the overall ranking.

### CROSS-REFERENCE TO RELATED PATENT APPLICATIONS

This application claims priority to U.S. Provisional Application No. 62/595,666 filed on Dec. 7, 2017, the content of which is hereby incorporated by reference in its entirety.

### BACKGROUND

Claims for damaged goods being returned require a visual inspection by a full time customer service associate to evaluate them. The reviewer typically works for the merchant. The customer service associate also typically evaluates claims independently of other facilities of the merchant.

### BRIEF DESCRIPTION OF DRAWINGS

Illustrative embodiments are shown by way of example in the accompanying drawings and should not be considered as a limitation of the present disclosure:

FIG. 1 is a block diagram illustrating a system for the distributed approval of image-based claims according to an exemplary embodiment.

FIG. 2A is a diagram illustrating a graphical user interface for the distributed approval of image-based claims according an exemplary embodiment.

FIG. 2B is a diagram illustrating another graphical user interface for the distributed approval of image-based claims according an exemplary embodiment.

FIG. 2C is a diagram illustrating an additional graphical user interface providing statistics based on the distributed approval of image-based claims according an exemplary embodiment.

FIG. 3 is a flowchart illustrating a process for the distributed approval of image-based claims according an exemplary embodiment.

FIG. 4 is a flowchart illustrating another process for the distributed approval of image-based claims according an exemplary embodiment.

FIG. 5 is a block diagram illustrating an electronic device for the distributed approval of image-based claims according to an exemplary embodiment.

### DETAILED DESCRIPTION

Described in detail herein are systems and methods that generate views containing a mix of images of damaged or poor quality items and/or undamaged or good quality items. The system allow a group of individuals to rank images of items in order of most desirable to least desirable using one or more control images. The rankings may be evaluated by the system using predetermined criteria to first identify potential erroneous responses from the individuals. The rankings may then be used by the system to approve or deny claims without further user input.

In one embodiment a control image may depict an item in a known state of damage or poor quality. Alternatively the control image may depict the item in a known undamaged or high quality condition. In an embodiment, the system may also retrieve more than one control image for inclusion in a generated view of images. The system may also identify potential control images for future use in claim evaluation based on their ranking. In an embodiment, the reviewing individuals receive a previous day's score when the system evaluates the claims for the previous day. Points in the score may be granted for valid answers that align with the average ranking of the images. The points may have a commercial value determined by the entity evaluating the images to encourage accuracy and trustworthiness from the individuals ranking the images.

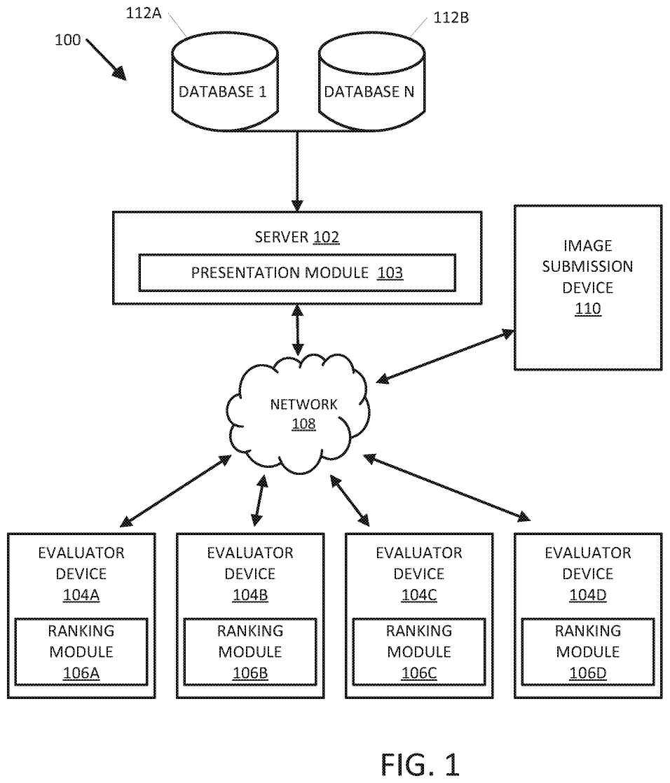

FIG. 1 is a block diagram 100 illustrating a system for the distributed approval of image-based claims according to an exemplary embodiment.

The exemplary system may include a server 102. In one embodiment, the server 102 may reside in a shared computing environment or data center. Alternatively, the server 102 may be a stand-alone desktop personal computer. In another embodiment, the server 102 may be a virtual instance executing in a virtual machine. Functionally, the server 102 may provide interfaces to evaluator devices 104A, 104B, 104C, 104D, image submission device 110, and databases 112A, 112B. The server 102 may be configured to execute presentation module 103. Presentation module 103 is discussed further below. The server 102 may be communicatively connected to the external systems and subsystems in the system. The connections may be wireless or wired. Wireless communication may be implemented in standards-based interfaces including WiFi and 4G Long Term Evolution (LTE). Other wireless communication standards may be used in implementation as long as the standards support the transmittal of images and claim information. Similarly, the server 102 may be connected through wired connections. The wired connections may include any physical medium to support the transmittal of images and claim information.

The exemplary system also includes an image submission device 110. The image submission device 110 may be a mobile device such as but not limited to a cellular handset, tablet, portable computer, specialized electronic handheld, or other electronic device equipped with imaging capabilities. The image submission device may have software enabling the capture of an optical image as well as the creation of a digital message to include one or more optical images that may be submitted to the server 102. The submission of the digital message with the image may take the form of an image-based claim.

Presentation module 103 may receive images from image submission device 110 and combine them with other images of the same item showing lesser or greater amounts of damage or lesser or greater deteriorations in item quality. Presentation module 103 may generate a view of images including the image received from image submission device 110 and may send the assembled view to multiple evaluator devices for image evaluation. Presentation module 103 also receives rankings from individuals associated with respective evaluator devices and programmatically determines an overall ranking for the image based on the multiple evaluator rankings. The overall ranking is compared by presentation module 103 to an overall ranking threshold and a claim associated with the submitted image is approved or refused based on the overall ranking meeting or not meeting the threshold. The approval/rejection decision is transmitted to the image submission device.

The network 108 may be a wide area network (WAN) or the Internet. The network 108 may be operable to transport data packets compatible with the evaluator devices 104A, 104B, 104C, 104D. In one embodiment, compatible data packets may include data packets with transmission control protocol (TCP) or user datagram protocol (UDP) routing information, as well as an accessible application layer. The network 108 may interface with the server 102, as well as other networks. The network 108 may be a combination of wired and wireless connection inclusively.

Evaluator devices 104A, 104B, 104C, 104D connect to a network 108. In an embodiment, the evaluator devices 104A, 104B, 104C, 104D may be mobile devices of varying hardware specifications. On each of the evaluator devices 104A, 104B, 104C, 104D, a connection to the network 108 may be supported. The connection may be wireless as illustrated, but also may be physically wired. The evaluator devices 104A, 104B, 104C, 104D may be operable to execute a mobile application in the form of a ranking module 106A, 106B, 106C, 106D capable of receiving input from a user and displaying multiple images. In one embodiment, the ranking module 106A, 106B, 106C, 106D may be a native application for each of the evaluator devices 104A, 104B, 104C, 104D. Alternatively the ranking module 106A, 106B, 106C, 106D may be a common application accessible through a common interface such as a web browser, or third party application.

The ranking modules 106A, 106B, 106C, 106D may receive and display a view containing more than one image received from the presentation module 103 executing on server 102. The images include control images and claim images. The claim images may be received from image submission device 110 and may be stored in one or more tables in the databases 112A, 112B. Likewise the control images may be stored in one or more tables in the databases 112A, 112B. Alternatively both the control images and the claim images may be stored in the same tables, however, a field may be set in each record corresponding to an image, indicating whether the image is a claim image or a control image. The ranking modules 106A, 106B, 106C, 106D receive an input ranking from user's of the respective evaluator devices 104A, 104B, 104C, 104D ranking the images with respect to each other in order from most to least damaged (or least damaged to most damaged) or best to worst condition (or worst condition to best condition). The rankings are transmitted from evaluator devices 104A, 104B, 104C, 104D to server 102 and presentation module 103 to perform claim evaluation.

Databases 112A, 112B may be standalone, as illustrated or may physically reside on the server 102. In a distributed environment, the databases 112A, 112B handle requests from the server 102 necessary to support display of images and receipt of input from the ranking modules 106A, 106B, 106C, 106D. The databases 110A, 110B may collectively include claims, claims-based images, control images, and claim statuses as described herein.

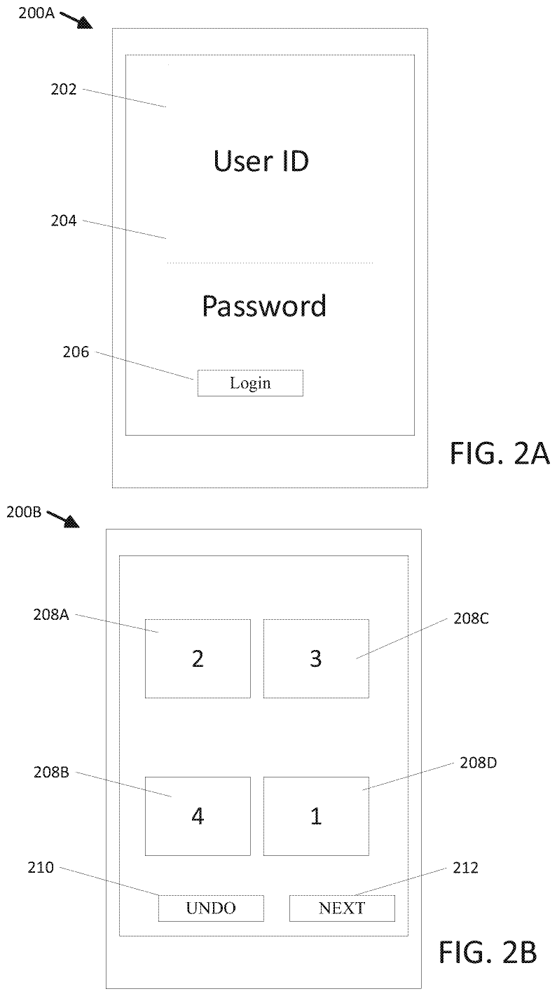

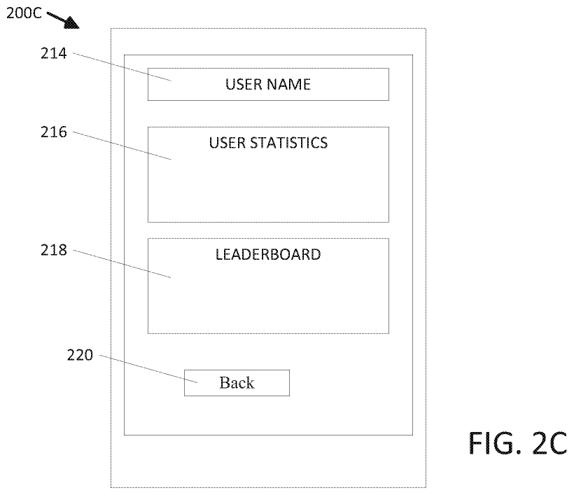

FIG. 2A is diagram illustrating a graphical user interface for the distributed approval of image-based claims according to an exemplary embodiment. The graphical user interface as described is an evaluator-facing portion of the ranking module 106A, 106B, 106C, 106D.

The graphical user interface (GUI) presents a user identification 202 prompt. The prompt may be a GUI widget that allows textual user input, such as a text box. The evaluator identifies themselves to the system utilizing the user identification prompt 202 as provided to the prompt. Additionally, for authentication purposes, a password prompt 204 is provided in a similar input widget as the user identification. The combination of the user identification prompt 202 and the password prompt 204 may be enough to identify and authenticate an evaluator with the system. The corresponding validation information may be contained in the databases 112A, 112B. The server 102 retrieves a stored password based on the user identification 202, and compares it to the provided password 202, when the login button 206 is clicked.

FIG. 2B is diagram 200B illustrating another graphical user interface for the distributed approval of image-based claims according an exemplary embodiment.

Upon evaluator identification and authentication, the ranking modules 106A, 106B, 106C, 106D display images 208A, 208B, 208C, 208D. The ranking modules 106A, 106B, 106C, 106D may include one or more images from the submission of the claim. The ranking modules 106A, 106B, 106C, 106D display two or more images. The ranking modules 106A, 106B, 106C, 106D display the images in a randomized order to eliminate any bias. The randomized order may be determined by the presentation module 103 or may be determined by the ranking modules 106A, 106B, 106C, 106D. For example, the retrieval logic performed by the presentation module 103 may retrieve the control images first. The randomized order allows the control images to be displayed throughout the panel of images, rather than first as they were retrieved. Additionally the presentation module 103 or the ranking modules 106A, 106B, 106C, 106D may determine an arrangement pattern for displaying the images. As illustrated in FIG. 2B, four images 208A, 208B, 208C, 208D are displayed in a two by two (2×2) matrix. Alternatively, a grid pattern may be used, as well as a list view pattern. It will be appreciated that other image arrangements are also within the scope of the present invention. As the evaluator examines the images, the ranking modules 106A, 106B, 106C, 106D may receive input to be interpreted as rankings. In one non-limiting example, the ranking may include touching the images in order from least damaged to most damaged, where the ranking modules 106A, 106B, 106C, 106D assigns a numeric value based on the order touched. In an embodiment with four images, the ranking modules 106A, 106B, 106C, 106D may apply the numeric value of four (4) for the most damaged and one for the least damaged. As an evaluator selects the images in this order, the ranking modules 106A, 106B, 106C, 106D may update the display to indicate the numeric association of each image. In FIG. 2B, image 208B rates as the most damaged item, while image 208D rates as the least damaged item.

The user interface 200B may include an undo button 210 when the evaluator is not satisfied with the ranking. The undo button 210 removes any display or association of ranking to all of the images 208A, 208B, 208C, 208D. The next button 212 submits the selected ranking of the images 208A, 208B, 208C, 208D by the evaluator to the server 102 for further processing by the presentation module. Prior to the selection of the ranking of the images 208A, 208B, 208C, 208D, the next button 212 may be disabled to prevent an evaluator from improperly ranking and submitting.

FIG. 2C is diagram 200C illustrating a further graphical user interface providing statistics based on the distributed approval of image-based claims according an exemplary embodiment. A user name 214 may be presented in the GUI to identify the user ID 202 in a more human readable fashion. The databases 112A, 112B may contain records that correlate the user name 214 to the user ID 202 upon authentication. Alternatively, if no relationship exists, the user identification 202 text may be used to populate the user name 214 field.

The GUI may include user statistics 216. User statistics 216 may include information relating to the number of image-based claims the evaluator has ranked over the evaluator's lifetime, the number of image-based claims the evaluator has ranked over the past twenty four hours, and the average deviation of the evaluator's rankings against the averaged historical rankings of approved claim-based images. User statistics may be received from the server 102 and presentation module 103 and periodically updated based upon the evaluator's submissions.

The GUI 200C may include a leaderboard 218. The leaderboard 218 may include a listing of all participating evaluators ranked by their related metrics including but not limited to number of claims-based image rankings submitted, frequency of claim-based image rankings submitted, and lowest deviation of average ranking against the average historical ranking of approved claim-based images. A back button 220 may return the evaluator to the GUI used for ranking image-based claims.

The presentation module 103 weights an evaluator based on historical ranking accuracy and contribution amount. The historical ranking accuracy is based on past evaluator rankings by the evaluator in relation to all the evaluators rankings for the same image based claim. For example, in one embodiment, each evaluator ranking is considered to determine how far it deviates from an average or median result determined by the other evaluators of the same image. Pre-determined criteria regarding acceptable deviation is applied by the presentation module 103 to determine if a ranking was historically accurate. Individual historical accuracy rankings are combined and averaged to determine an overall historical ranking accuracy for the evaluator. The contribution amount of rankings by the evaluator over different time periods is also considered. Both the historical ranking accuracy and the contribution amount are utilized to weight an evaluator's ranking in determining the claim status of an image-based claim.

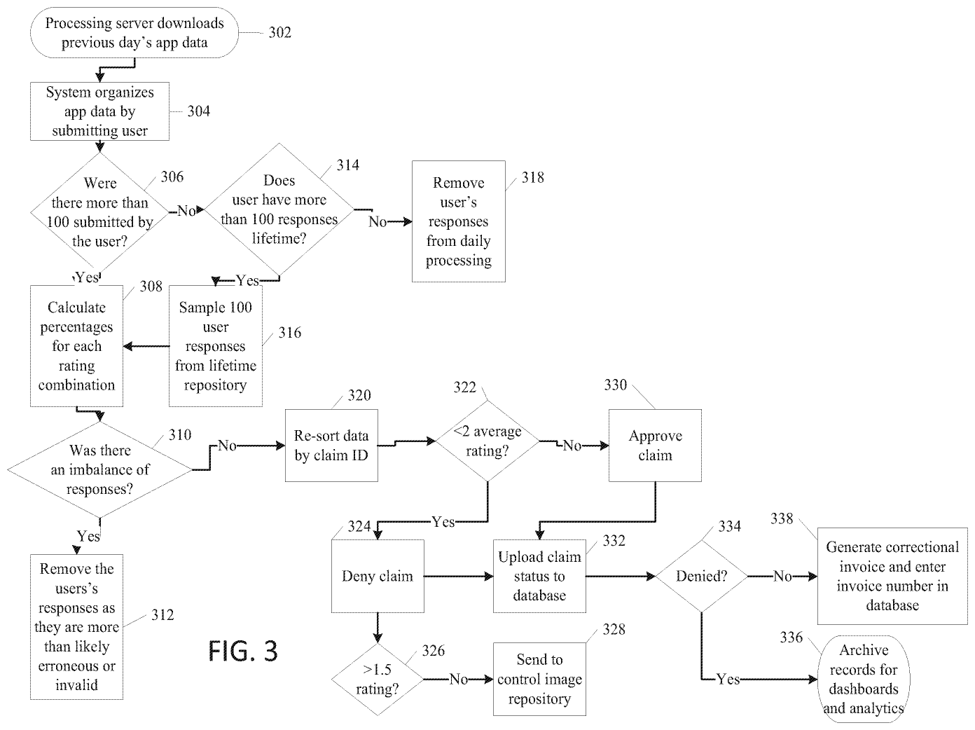

FIG. 3 is a flowchart illustrating a process for the distributed approval of image-based claims according an exemplary embodiment.

At step 302, a processing server 102 will download a previous day's application data. The server 102 receives application data from the ranking modules 106A, 106B, 106C, 106D of one or more evaluator devices 104A, 104B, 104C, 104D. The application data may be transmitted to the server 102 through a network connection including the internet, WAN, or WLAN connections. Alternatively, the previous day's application data may be transmitted to the server 102 upon submission and held in queue until a time period has passed prior to processing. The application data may be a series of rankings of image based-claims.

At step 304, system organizes the application data by submitting user. The application data may be indexed and stored in the databases 112A, 112B based on user identification 202.

The presentation module 103 then determines whether there more than one hundred (100) evaluations submitted by the evaluator at step 306. The server 102 may perform a database query in a structured query language based on user ID 202 over a period of time (e.g., the last twenty four hours). The result from the database query may contain the number of records that meet the criteria of the database query. The resultant record count may be compared against the threshold. Alternatively, the threshold is another number set as high as or as low as a system administrator determines. The goal of the threshold is to eliminate spurious data that may cause data trends to be skewed.

At step 314, if the evaluator's submissions in the last twenty four hours are less than one hundred, the system determines if the evaluator has submitted more than one hundred (100) responses over the lifetime of their enrollment with the system. The determination may utilize the resultant record count of a database query indexing on the user ID over the lifetime of the data set, with no time restriction. As with the daily threshold, the one hundred lifetime responses threshold is customizable and is an implementation choice that may be adjusted to provide more accurate rankings.

If there are under one hundred lifetime responses, the evaluator's responses may be removed from daily processing at step 318. An evaluator who has not provided one hundred lifetime responses may be removed from the daily processing until they pass the threshold. The received previous day's application data may be stored in the databases 112A, 112B for future processing once the evaluator surpasses the threshold for lifetime responses.

If the evaluator has submitted over one hundred or more lifetime responses, the system samples one hundred evaluator responses from lifetime repository records in the database at step 316. The sampling may be a random sampling of one hundred responses from the databases 112A, 112B. Alternatively, the sampling may be the last one hundred responses.

If there are more than one hundred responses have been submitted by the evaluator in the previous day's application data, the presentation module calculates percentages for each rating combination at step 308. The system determines an average ranking from multiple evaluators based on one image-based claim. The system determines a percentage for each of the combination of the submitted rankings. The percentage may be a percent deviation of each ranking of the image-based claim from the average combination of rankings as submitted by all uses for the one image-based claim. The process determines a percentage deviation across all submitted image-based claim rankings submitted by the evaluator in the application data.

The system also may determine if there was an imbalance of responses at step 310. To do so, the system determines a threshold deviation of cumulative rankings for an evaluator against all rankings provided by all evaluators for the same set of image-based claims. The threshold would be determined by a system administrator, however, the threshold could be altered subsequently automatically if too many submissions are being discarded.

If there is an imbalance of responses, the presentation module removes the evaluator's responses as they are more than likely erroneous or invalid at step 312. If an evaluator's responses pass a response threshold, meaning that their responses, cumulatively, are outliers from all rankings, then the evaluator's responses are removed from further consideration and are marked as erroneous or invalid. The server 102 may update flags in the databases 112A, 112B indicating that the submitted responses have been discarded. Alternatively, as the threshold is tuned based on the total number of discarded responses across all evaluators, the submitted responses (now discarded) may be utilized again when the threshold has changed, as they may no longer be outliers.

If there was not an imbalance of responses, the system re-sorts the submitted application data by claim identifier at step 320. The database 112A, 112B tables may be queried based on a claim identifier linked to the initial claim submission. The claim identifier field may persist across all records of image-based claim rankings submitted by all evaluators.

At step 322, the system determines whether the claim has less than a minimum specified ranking. For example, in evaluations analyzing views containing 4 ranked images being ranked 1-4 with 1 being the least damaged and 4 being the most damaged, the minimum ranking may be specified as “2”. The system evaluates each claim, as identified by its claim identifier, and sums all of the rankings submitted by all evaluators. The summation is then divided by the number of records corresponding to the claim identifier, thereby providing an average for the claim linked to the claim identifier. If the average is less than a two ranking, it is determined that the item pictured in the image is not damaged sufficiently to justify the claim. In other embodiments, where the number of images to be displayed is greater or fewer, then the specified minimum ranking may be adjusted respectively.

In this embodiment, if the average is two or greater, the claim is approved at step 330. The average of two or greater indicates that the ranking based on damage is sufficient to approve the claim. If the average is less than a two rating, the claim is denied at step 324. A claim with a ranking of less than two, indicates that the item in the images is not damaged enough to justify approval of the claim.

At step 325, the system determines whether the claim has a greater than one and a half (1.5) rating. If the average ranking is not greater than 1.5, the image may be sent to control image repository at step 328 as indicative of an item in an undamaged condition that can serve as a control image in future rankings for the item. The image may be stored in a repository in the databases 112A, 112B to be retrieved later and presented in the ranking modules 106A, 106B, 106C, 106D.

After the claim is approved or denied, the claim status is updated in the database at step 332. The database records for the claims may be updated to indicate their status. The field in the schema for the table may be a Boolean value indicating approved (true) or denied (false).

Once the database has been updated, the system queries whether the claim was denied, at step 334. The claim may be retrieved from the databases 112A, 112B by claim identifier. The resultant record from the query may be accesses and the field corresponding to claim status may be evaluated. In the above example, claim status implemented via Boolean value with a false field value may indicate a denied claim.

If the claim was denied, the records are archived for dashboards and analytics at 336. Analytics may be provided to a system administrator to provide information regarding the number and frequency of denied claims. The analytics may be utilized for adjusting thresholds in the process to enable fairness of claim approval and denial, as well as the discard of spurious and erroneous image ranking submissions.

If the claim was approved, the system may generate a correctional invoice and enter the invoice number in database at step 338. The system may query the database based on the claim identifier and update a record corresponding to the claim. A field may be included that may hold an invoice number, or alternatively a database identifier key corresponding to a record in another database the host's invoices. The individual submitting the claim may be programmatically notified of the claim handling decision by the presentation module 103.

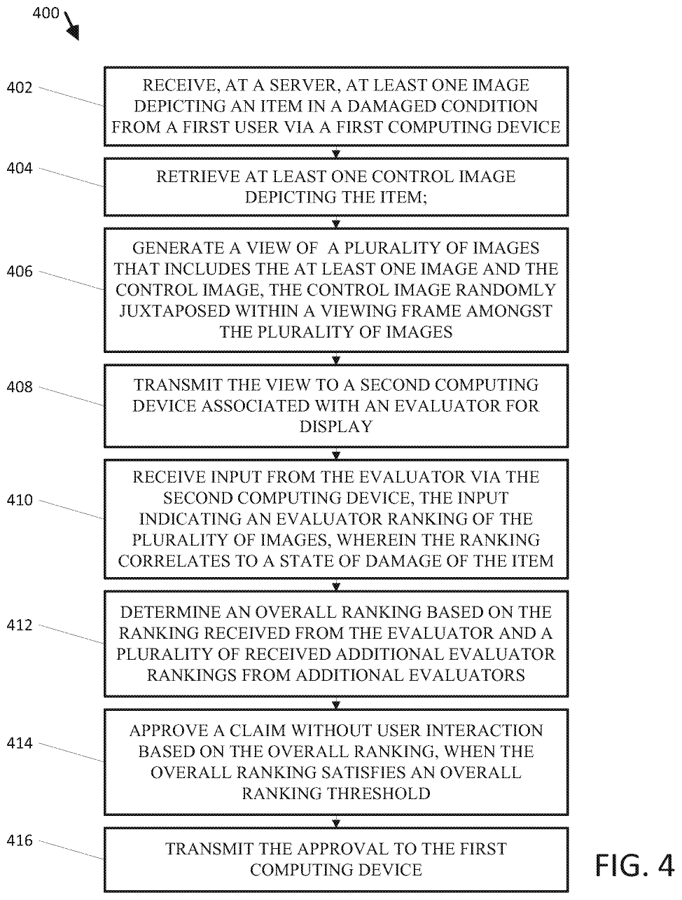

FIG. 4 is a flowchart illustrating a process for the distributed approval of image-based claims according to an exemplary embodiment.

At step 402, the system receives, at a server 102, at least one image depicting an item in a damaged condition from a first user via a first computing device. The first computing device may be image submission device 110. The image submission device 110 creates a message containing the at least one image as well as relevant submitting user information to be received at server 102. The message contains information for the formation of an image-based claim to be handled by presentation module 103.

At step 404, the system retrieves at lease one control image depicting the same type of item. The control image may be retrieved by the server 102 from the databases 112A, 112B through a SQL request. Control images may be retrieved from the databases 112A, 112B based on fields in records of the control images that correspond to the item depicted in the images.

At step 406, the presentation module generates a view of multiple images that includes the at least one image submitted for the claim and the control image, the control image randomly juxtaposed in a viewing frame amongst the images. The system utilizes the submitted image of the item as well as the control image of the item to generate a panel of images of the item. The panel of items includes random positioning within the viewing frame as to eliminate any biases that may exist based on algorithmic choices for retrieval of the images.

At step 408, the system transmits the view to a second computing device associated with an evaluator for display. For example, the presentation module 103 transmits the view via the server 102 to the ranking modules 106A, 106B, 106C, 106D for rendering on at least one of the evaluator devices 104A, 104B, 104C, 104D. In one embodiment, the view is transmitted as an integrated view already assembled. In another embodiment, the individual images for the view are separately sent to the evaluator devices 104A, 104B, 104C, 104D for assembly into a viewing frame by the ranking modules 106A, 106B, 106C, 106D.

At step 410, the presentation module 103 receives input from the evaluator via the second computing device, the input indicating an evaluator ranking of the images, where the ranking correlates to a state of damage of the item. As described above, the input may be a numeric based ranking based on an order in which the evaluator selects images in the ranking modules 106A, 106B, 106C, 106D.

At step 412, the presentation module 103 determines an overall ranking based on the ranking received from the evaluator and the other received additional evaluator rankings from additional evaluators. The system ignores erroneous submissions as well as statistical outliers and calculates a ranking average based on all the submissions from all the ranking modules 106A, 106B, 106C, 106D.

At step 414, the presentation module 103 approves a claim without user interaction based on the overall ranking, when the overall ranking satisfies an overall ranking threshold. The average ranking across all evaluators may be compared against an approval threshold. Database 112A, 112B tables may be updated based on meeting the threshold for approval.

At step 416, the presentation module 103 transmits the approval to the first computing device. The server 102 retrieves the claim record from the databases 112A, 112B. Upon examining the record for an approval field, the resultant value of that field is transmitted to the image submission device 110 to indicate to the submitting user the state of their claim.

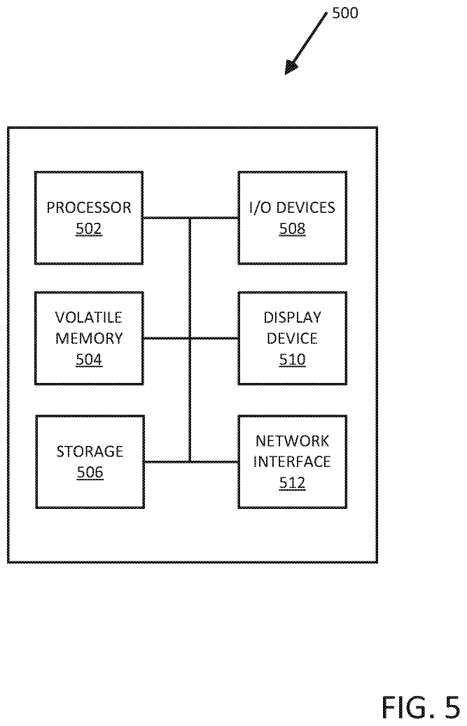

FIG. 5 is a block diagram illustrating an electronic device for the distributed approval of image-based claims according to an exemplary embodiment.

A computing device 500 supports the submission and evaluation of image-based claims. The computing device 500 may embody the server 102, the image submission device 110 and the evaluator device 104. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, volatile memory 504 included in the computing device 500 may store computer-readable and computer-executable instructions or software for implementing exemplary operations of the computing device 500. The computing device 500 also includes configurable and/or programmable processor 502 for executing computer-readable and computer-executable instructions or software stored in the volatile memory 504 and other programs for implementing exemplary embodiments of the present disclosure. Processor 502 may be a single core processor or a multiple core processor. Processor 502 may be configured to execute one or more of the instructions described in connection with computing device 500.

Volatile memory 504 may include a computer system memory or random access memory, such as DRAM, SRAM, EDO RAM, and the like. Volatile memory 504 may include other types of memory as well, or combinations thereof.

A user may interact with the computing device 500 through a display 510, such as a computer monitor, which may display one or more graphical user interfaces supplemented by I/O devices 508, which may include a multi-touch interface, a pointing device, an image capturing device and a reader.

The computing device 500 may also include storage 506, such as a hard-drive, CD-ROM, or other computer-readable media, for storing data and computer-readable instructions and/or software that implement exemplary embodiments of the present disclosure (e.g., applications). For example, storage 506 may include one or more storage mechanisms for storing information associated with viewed and ultimately bought scores and latent attributes and may be indexed accordingly. The storage mechanism may be updated manually or automatically at any suitable time to add, delete, and/or update one or more data items locally or virtually in the in the databases 112A, 112B when attached.

The computing device 500 may include a network interface 512 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the network interface 512 may include one or more antennas to facilitate wireless communication between the computing device 500 and a network and/or between the computing device 500 and other computing devices. The network interface 512 may include a built-in network adapter, network interface card, PCMCIA network card, card bus network adapter, wireless network adapter, USB network adapter, modem or any other device suitable for interfacing the computing device 500 to any type of network capable of communication and performing the operations described herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components, or steps may be replaced with a single element, component, or step. Likewise, a single element, component, or step may be replaced with multiple elements, components, or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts and that the steps in the exemplary flowcharts may be performed in a different order than the order shown in the illustrative flowcharts.

We claim:

1. A computing-device implemented system for the distributed approval of image-based claims comprising:
a server;
a first computing device communicatively coupled to the server;
a presentation module configured to execute on the server, wherein the presentation module is configured to:
receive at least one image depicting an item in a damaged condition from a first user via the first computing device;
retrieve at least one control image depicting the item;
generate a view of a plurality of images that includes the at least one image and the control image, the control image randomly juxtaposed within a viewing frame amongst the plurality of images;
transmitting the view to a second computing device associated with an evaluator for display;
receive input from the evaluator via the second computing device, the input indicating an evaluator ranking of the plurality of images, wherein the ranking correlates to a state of damage of the item;
determine an overall ranking based on the ranking received from the evaluator and a plurality of received additional evaluator rankings from additional evaluators;
approve a claim without user interaction based on the overall ranking, when the overall ranking satisfies an overall ranking threshold; and
transmit the approval to the first computing device.

2. The system of claim 1 wherein the at least one control image depicts the item in a known state of damage.

3. The system of claim 1 wherein the at least one control image depicts the item in an undamaged condition.

4. The system of claim 1 wherein the presentation module is further configured to:
determine a historical ranking accuracy for the evaluator, wherein the historical ranking accuracy is based on a plurality of past evaluator rankings for the evaluator;
determine a contribution amount for the evaluator, wherein the contribution amount is based at least in part on a number of evaluator ranking submissions the evaluator has previously submitted; and
weighting the evaluator ranking when determining the overall ranking based on the historical ranking accuracy satisfying a first threshold and the contribution amount satisfying a second threshold.

5. The system of claim 4 wherein the past evaluator rankings for the evaluator is based on a consistency of past evaluator ranking submissions by the evaluator with previously determined overall rankings for those submissions.

6. The system of claim 1, wherein the presentation module is further configured to retrieve at least a second control image for inclusion as one of the plurality of images.

7. The system of claim 1 wherein the presentation module is further configured to receive at least a second image from the first user for inclusion in the plurality of images.

8. The system of claim 1, wherein the historical ranking accuracy is based at least in part on an average duration of time between submission of each of the plurality of past rankings.

9. The system of claim 1, the presentation module is further configured to generate an override message indicating a denial of the claim based on.

10. A method for the distributed approval of image-based claims comprising:
receiving, at a server, at least one image depicting an item in a damaged condition from a first user via a first computing device;
retrieving at least one control image depicting the item;
generating a view of a plurality of images that includes the at least one image and the at least one control image, the at least one control image randomly juxtaposed within a viewing frame amongst the plurality of images;
transmitting the view to a second computing device associated with an evaluator for display;
receiving input from the evaluator via the second computing device, the input indicating an evaluator ranking of the plurality of images, wherein the ranking correlates to a state of damage of the item;
determining an overall ranking based on the ranking received from the evaluator and a plurality of received additional evaluator rankings from additional evaluators;
approve a claim without user interaction based on the overall ranking, when the overall ranking satisfies an overall ranking threshold; and
transmitting the approval to the first computing device.

11. The method of claim 10, wherein the at least one control image depicts the item in a known state of damage.

12. The method of claim 10, wherein the at least one control image depicts the item in an undamaged condition.

13. The method of claim 10 further comprising:
determining a historical ranking accuracy for the evaluator, wherein the historical ranking accuracy is based on a plurality of past evaluator rankings for the evaluator;
determining a contribution amount for the evaluator, wherein the contribution amount is based at least in part on a number of evaluator ranking submissions the evaluator has previously submitted; and
weighting the evaluator ranking when determining the overall ranking based on the historical ranking accuracy satisfying a first threshold and the contribution amount satisfying a second threshold;

14. The method of claim 13 wherein the past evaluator rankings for the evaluator is based on a consistency of past evaluator ranking submissions by the evaluator with previously determined overall rankings for those submissions.

15. The method of claim 10, further comprising retrieving at least a second control image for inclusion as one of the plurality of images.

16. The method of claim 10, further comprising receiving at least a second image from the first user for inclusion in the plurality of images.

17. The method of claim 10, wherein the historical ranking accuracy is based at least in part on an average duration of time between submission of each of the plurality of past rankings.

18. The method of claim 10, further comprising generating an override message indicating a denial of the claim.

19. A non-transitory computer readable medium, having stored thereon, instructions that when executed in a computing system, cause the computing system to perform operations comprising:
receiving, at a server, at least one image depicting an item in a damaged condition from a first user via a first computing device;
retrieving at least one control image depicting the item;
generating a view of a plurality of images that includes the at least one image and the control image, the control image randomly juxtaposed within a viewing frame amongst the plurality of images;
transmitting the view to a second computing device associated with an evaluator for display;
receiving input from the evaluator via the second computing device, the input indicating an evaluator ranking of the plurality of images, wherein the ranking correlates to a state of damage of the item;
determining an overall ranking based on the ranking received from the evaluator and a plurality of received additional evaluator rankings from additional evaluators approve a claim without user interaction based on the overall ranking, when the overall ranking satisfies an overall ranking threshold; and
transmitting the approval to the first computing device.

20. The non-transitory computer readable medium of claim 19, the instructions further causing the computing system to perform operations comprising:
determining a historical ranking accuracy for the evaluator, wherein the historical ranking accuracy is based on a plurality of past evaluator rankings for the evaluator;
determining a contribution amount for the evaluator, wherein the contribution amount is based at least in part on a number of evaluator ranking submissions the evaluator has previously submitted; and
weighting the evaluator ranking when determining the overall ranking based on the historical ranking accuracy satisfying a first threshold and the contribution amount satisfying a second threshold.
